(19) United States
(12) Patent Application Publication
(10) Pub. No.: US 2019/0049922 A1
(43) Pub. Date: Feb. 14, 2019

(54) METHOD FOR PROVIDING A FLUID SUPPLY DEVICE AND USE THEREOF

(71) Applicant: Klingelnberg AG, Zürich (CH)

(72) Inventor: Rolf Schalaster, Wermelskirchen (DE)

(21) Appl. No.: 16/079,647

(22) PCT Filed: Feb. 2, 2017
(86) PCT No.: PCT/EP2017/052267

§ 371 Date: Aug. 24, 2018

(30) Foreign Application Priority Data
Feb. 24, 2016 (DE) 10 2016 103 202.6

(51) Int. Cl. G05B 19/4099; B23Q 11/10

(52) U.S. Cl. CPC G05B 19/4099; G05B 2219/35079; G05B 2219/49023; B23Q 11/1076

(57) ABSTRACT

Method for providing a fluid feeding device, which is designed specifically for use in a machining zone of a machine tool in order to deliver a fluid in the direction of an area of interaction between a tool and a workpiece, comprising the following steps: a. computer-aided definition of the 3-dimensional configuration of the machining zone, taking into account the workpiece and the tool that is to be used for machining the workpiece in the machining zone of the machine tool, b. computer-aided definition of the 3-dimensional form and the position of at least one specifically adapted outlet nozzle (251) of the fluid feeding device, with the inclusion of information that was defined in step a., c. provision of a data record that describes the 3-dimensional form of this outlet nozzle (251), d. use of the data record to produce this outlet nozzle (251) by means of a numerically controlled production process (200).

The present invention relates to methods for providing a fluid supply device, which is capable of cooling and/or lubricating components/workpieces during or after cutting machining. Moreover, it relates to the use of a fluid supply device.

The priority of patent application DE 10 2016 103 202.6 is claimed, which was filed on 24 Feb. 2016 in the name of the present applicant with the German Patent and Trademark Office.

### PRIOR ART

Using a coolant or lubricant during cutting (metal) machining (for example, during gear tooth grinding) is known. Present machine tools and machining centers (for example, the bevel gear machine tool 100 shown in FIG. 1) are therefore often equipped with a high-performance liquid agent supply 50. Details of a conventional fluid supply device 50, which comprises multiple rigidly constructed outlet nozzles 51, are shown in FIGS. 2A and 2B.

A gooseneck-type head is usually assembled and set manually such that the liquid jet which exits from the head strikes the point to be machined, for example, of a workpiece 30 (an exemplary bevel gear workpiece 30 is shown in FIG. 1). In addition to the solely cooling or lubricating effect, this also relates to efficiently transporting away the chips which arise.

It has been shown that the setting of the liquid agent supply 50 is not always optimal. Under certain circumstances, the full effect therefore cannot be achieved. On the other hand, situations occur again and again in which a collision with elements of the liquid agent supply 50 occurs during movements of the machine axes (for example, of the machine 100), if, for example, a gooseneck-type head was not installed in the accurately predetermined position.

Moreover, because of the various parts which typically have to be joined together during the assembly of a fluid supply device 50, leaks can occur.

A conventional fluid supply device 50 typically comprises differently configured outlet nozzles 51, wherein each of these outlet nozzles 51 is assembled, for example, from a plug or screw coupling 59 (which is designed, for example, for coupling in the region of a docking point 52 onto a ring line 53), of pipe pieces 54, 57, a knee joint 56, at least one union nut 61 as a screw connection, and a nozzle head 60 (which comprises a ball jet, for example).

The example of a further rigid outlet nozzle 51 according to the prior art is shown in FIG. 5A.

The object presents itself of providing a technical approach for particularly effective cooling and/or lubricating of workpieces during cutting machining. In this case, the respective optimum position of the elements is to be found for this machining and collisions are to be avoided.

The object is achieved according to the invention by a method according to claim 1. Advantageous embodiments of the invention form the subjects of the dependent claims.

The method according to the invention is directed to providing a fluid supply device which is especially designed for use in the machining zone of the machine tool.

The invention relates to a method for providing a fluid supply device which is especially designed for use in a machining zone of a machine tool, in order to discharge a fluid in the direction of an interaction region between a tool and a workpiece. The method comprises the following steps:

a. computer-assisted definition of the 3-dimensional configuration of the machining zone in consideration of the workpiece and the tool which is to be used for machining the workpiece in the machining zone of the machine tool,

b. computer-assisted definition of the 3-dimensional shape and the position of at least one specifically adapted outlet nozzle of the fluid supply device with incorporation of information which was defined in step a.,

c. providing a dataset which describes the 3-dimensional shape of this outlet nozzle,

d. using the dataset to produce this outlet nozzle by means of a numerically controlled manufacturing method.

The mentioned steps are preferably, but not necessarily, carried out in the mentioned sequence.

In all embodiments, a material-depositing method is preferably used as the numerically controlled manufacturing method. This is particularly preferably a 3D printing method.

Preferably, in all embodiments, in the scope of step a., the configuration of the machining zone is established (for example, by defining a 3-dimensional space or by defining point clouds). This takes place using a computer and/or a CPU of the machine tool.

Preferably, in all embodiments, in the scope of step b., both the static and also the dynamic relative position of the workpiece and the tool are taken into consideration, which will occur during the machining of the workpiece using the tool.

The position of the workpiece in relation to the tool in the idle state is referred to as the static relative position. In contrast, the relative position of the workpiece which changes over time in relation to the tool is referred to as the dynamic relative position. In the definition of the dynamic relative position, the relative movements of workpiece and tool and the rotational movements of workpiece and tool are taken into consideration.

Preferably, in all embodiments, in the scope of step b., a collision ascertainment is performed in order to define the 3-dimensional shape and position of the outlet nozzle such that a collision does not occur during the use of the outlet nozzle in the machining zone.

Preferably, in all embodiments, in the scope of step b., a flow observation is performed in order to define the 3-dimensional shape of the outlet nozzle such that the fluid can be discharged in the form of a direct fluid jet in the direction of the interaction region between the tool and the workpiece. In this case, for example, this can relate to finding a position and shape of the outlet nozzle, which always enables the fluid jet to be oriented directly and without deflection (i.e., without interference) onto the interaction region in spite of the relative movement of the tool in relation to the workpiece.

Preferably, in all embodiments, software is used, which enables at least one basic shape of an outlet nozzle to be provided from a storage medium and/or via a communication connection. If an existing basic shape should be suitable for the upcoming machining, no dataset thus has to be provided and no special outlet nozzle has to be manufactured. I.e., in this case, the provision of the dataset only takes place if none of the selectable basic shapes is suitable because of the present 3-dimensional configuration of the machining zone. Effort and costs can be saved by this intelligent approach.

Preferably, in all embodiments, software is used, which enables the data of at least one selectable blank of an outlet nozzle to be provided from a storage medium and/or via a communication connection. If there is a suitable selectable blank, the selected blank is thus introduced into a manufacturing machine in step d. and adapted by the numerically controlled manufacturing method (for example, by the removal of material of the blank) or supplemented (for example, by embedding the blank in a suitable material).

In all embodiments, the dataset can be transferred to a manufacturing machine, for example, which is located at a different location than the computer or than the machine tool, on which or at which steps a. to c. were carried out.

This also relates to the use of at least one outlet nozzle, which was provided according to the method according to the invention, as part of the fluid supply device of a machine tool. In this case, this can be, for example, the ad hoc provision of suitable, specially manufactured outlet nozzles, the connection of these outlet nozzles, for example, to a ring line or another pressure line, and the use of this constellation in a machine tool.

This also relates above all to the use of a coolant or lubricant in liquid form or in gas form (referred to here in general as a fluid) during the cutting machining of workpieces and in particular of metal workpieces. The invention can be used, for example, in conjunction with the cutting wet machining of gearwheels.

The invention enables the provision of a fluid supply device or individual components of such a fluid supply device having a high performance capability. I.e., it relates above all to an individually adapted fluid supply device having high delivery power, which has the shortest possible delivery distance. To be able to ensure a high delivery power and a short delivery distance, the invention preferably uses a fixedly installable fluid agent supply instead of flexible lines and gooseneck-type pivotable outlet nozzles.

In order to be able to optimally align the (individual) outlet nozzle(s) of the fixed fluid supply device, according to the invention, a suitable shape and position are ascertained for each of the outlet nozzles in a computer-assisted optimization method, before these outlet nozzles are manufactured.

According to the invention, during the ascertainment of the shape and suitable position for an outlet nozzle, a type of collision computation is carried out to prevent a collision from occurring between the outlet nozzle or other elements of the fluid agent supply and the machine tool (for example, the tool of the machine tool).

Preferably, in all embodiments, an optimization computation of the fluid agent device is carried out, which results, on the one hand, in a less strongly pronounced wear behavior of the tools. On the other hand, the configuration of the machine tool can be executed more rapidly and incorrect settings are prevented, which can result in a collision of components of the fluid agent device with the tool or the workpiece.

The method of the invention therefore offers numerous advantages, which are shown, for example, as a shortening of the downtime of the machine tool. This is because the downtime of the machine tool can be reduced significantly if the suitable shape and position of the outlet nozzles of the fluid agent device were already ascertained beforehand and if the specially manufactured outlet nozzles are provided such that they solely have to be connected at the suitable position, for example, to a ring line or another line framework. Moreover, the frequency of errors is reduced.

The method of the invention can be used not only in conjunction with facilities which are used for cooling or lubrication, but rather facilities/configurations which are suitable for cleaning purposes can also be prepared this way. I.e., the invention may be applied to various outlet nozzles and/or fluids, independently of whether this relates to lubricating, cooling, or cleaning.

The method of the invention can be used not only in the chip-removing (metal) machining of workpieces, but rather it can also be used, for example, in the dressing of tools using a dressing tool (for example, using a dressing wheel). The method may also be used in the (re-)grinding of tools (for example, bar cutters) or in the deburring of workpieces. In these cases, the so-called workpiece is a component or a tool which is to be machined. The term workpiece is therefore accordingly to be interpreted broadly. The workpiece is therefore also referred to hereafter as the component to be machined.

The list of reference signs is part of the disclosure.

### DRAWINGS

The figures are described coherently and comprehensively. Exemplary embodiments of the invention are described in greater detail hereafter with reference to the drawings.

FIG. 1 shows a perspective view of a multiaxis grinding machine in which the invention can be used, for example;

FIG. 2A shows a perspective view of a part of a grinding machine (for example, a grinding machine according to FIG. 1), wherein the immediate environment of a cup wheel and a fixedly arranged conventional fluid agent supply is shown;

FIG. 2B shows a perspective view of a larger portion of FIG. 2A, wherein in addition to the cup wheel and the fixedly arranged fluid agent supply, an inclined workpiece spindle having a workpiece (a bevel gear here) are also shown;

FIG. 3 shows the symbol of a machine (material-depositing machine) which is designed for executing a material-depositing method;

FIG. 4 shows a schematic view of an exemplary overall facility of the invention (derived from the grinding machine according to FIG. 1), wherein some elements of the invention are connectable to the grinding machine;

FIG. 5A shows a perspective view of an outlet nozzle according to the prior art;

FIG. 5B shows a perspective view of an outlet nozzle of the invention;

FIG. 6A shows a view of a further fluid agent supply (with viewing direction from below of/on? a cup wheel), wherein this fluid agent supply comprises two conventional outlet nozzles;

FIG. 6B shows a view of a fluid agent supply (with viewing direction from below of/on? a cup wheel), wherein this fluid agent supply comprises an outlet nozzle manufactured according to the invention;

FIG. 7 shows a schematic illustration of individual exemplary steps of the invention,

FIG. 8 shows a view of an exemplary outlet nozzle of the invention observed from below;

FIG. 9 shows a schematic illustration of individual exemplary steps of the invention.

### DETAILED DESCRIPTION

Terms, which are also used in relevant publications and patents, are used in conjunction with the present description. However, it is to be noted that the use of these terms is merely to serve for better comprehension. The inventive concepts and the scope of protection of the patent claims are not to be restricted in the interpretation by the specific selection of the terms. The invention may be readily transferred to other term systems and/or technical fields. The terms are to be applied accordingly in other technical fields.

This relates here to the cooling and/or lubricating in conjunction with a chip-removing method for machining workpieces 30. In particular, the chip-removing method relates to the machining of metal workpieces 30, for example, gearwheels, shafts, clutch parts, and the like.

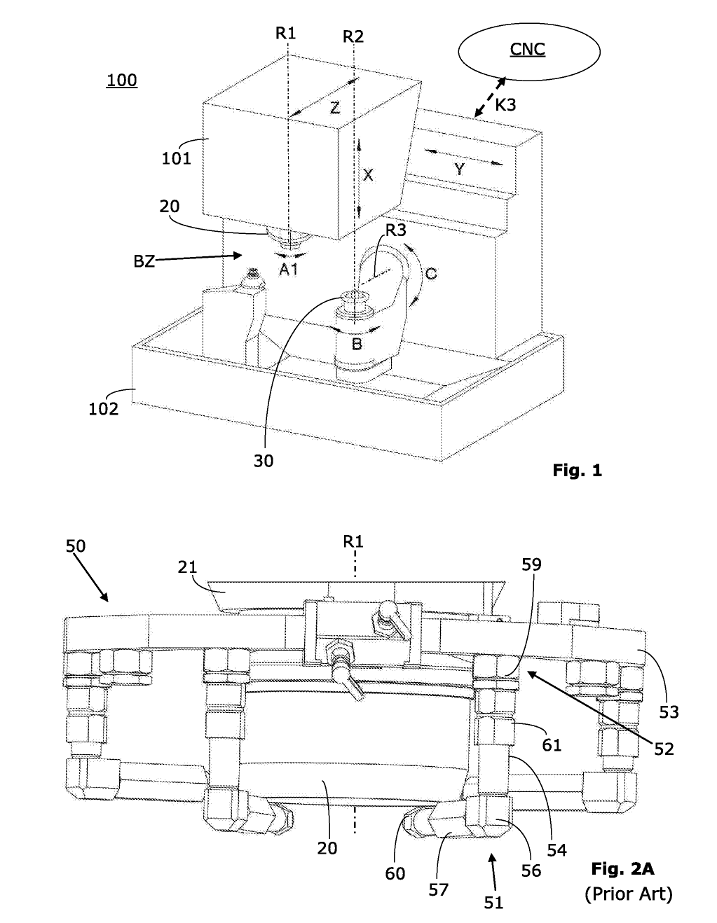

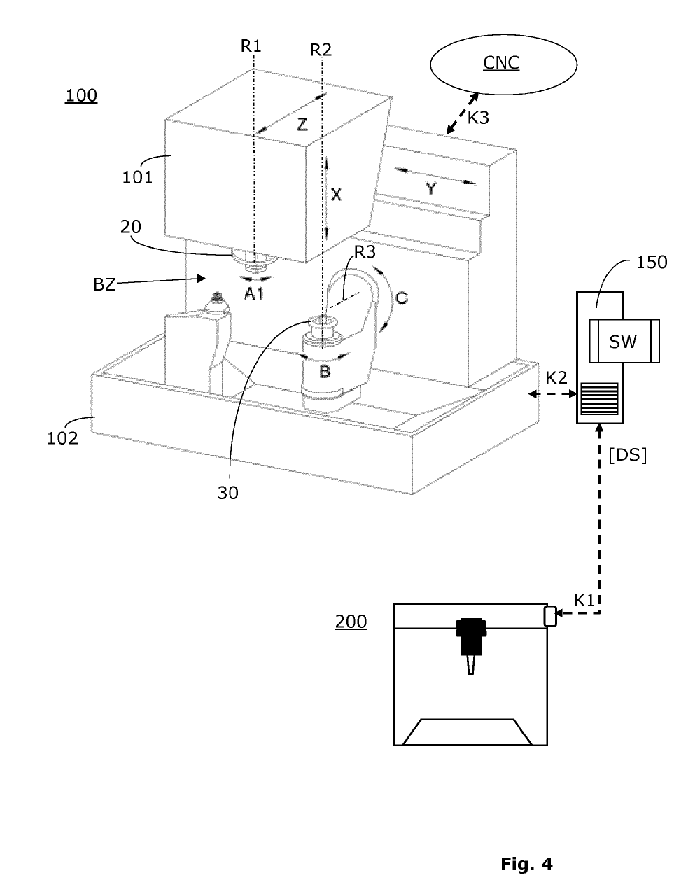

The method of the invention is especially designed for use in the environment of a machine tool 100, in which a component/workpiece 30 is machined by removing chips. An exemplary machine tool 100 is shown with its essential elements in FIG. 1. In FIG. 1, a (bevel gear) grinding machine 100 is shown. In FIG. 4, an exemplary machine tool 100 is shown, which is equipped according to the invention. The same reference signs are used for the same parts in FIGS. 1 and 4.

The invention is used, for example, in conjunction with machine tools 100, which are equipped with a CNC-controlled tool axis R1 and a CNC-controlled workpiece axis R2. The machine tool 100 shown in FIGS. 1 and 4 has, for example, six CNC-controlled axes and it comprises a CNC controller, which is indicated here by an oval. The communication connection between the CNC controller and the axes of the machine tool 100 is schematically shown by a double arrow K3.

The mentioned axes are, for example,

a linear axis X, which executes vertical movements of a tool carrier 101 in relation to a machine bed 102;

a linear axis Y, which executes first horizontal movements of the tool carrier 101 in relation to the machine bed 102;

a linear axis Z, which executes second horizontal movements of the tool carrier 101 in relation to the machine bed 102, wherein the first horizontal movements extend perpendicularly to the second horizontal movements;

a pivot axis C, which executes a pivot movement of a workpiece spindle 103 and a workpiece 30 fastened (for example, chucked) thereon about a horizontal axis R3;

an axis of rotation B, which executes a rotational movement of the workpiece spindle 103 and the workpiece 30 mounted thereon about the workpiece axis R2;

an axis of rotation A1, which executes a rotational movement of a tool spindle 21 and a tool 20 mounted thereon about the tool axis R1.

These movements are taken into consideration when defining the dynamic relative position of the workpiece and the tool.

Moreover, the machine tool 100 comprises a fluid supply device 50, which discharges a fluid under pressure through at least one outlet nozzle 51 in the direction of a machining zone BZ. The fluid supply device 50 is not shown in FIG. 1. The fluid supply device 50 of the prior art is designated with the reference signs 50 and following, the fluid supply device of the invention, in contrast, bears the reference signs 250 and following.

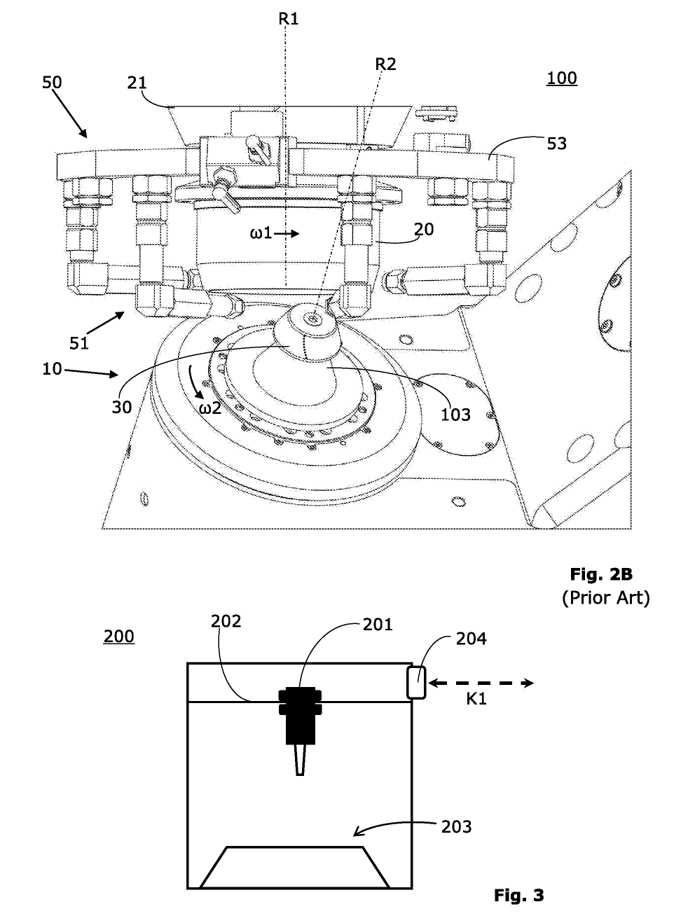

To be able to ensure a high delivery power and a short delivery distance, the invention preferably uses a fixedly installable fluid supply device 250 instead of flexible lines and gooseneck-type pivotable outlet nozzles. It is more complex to always set flexible lines exactly identically. A configuration having fixed ring line 53 (see, for example, FIG. 2A) is simple to set exactly identically again, in order to be able to specify the same conditions again during each machining of the special workpiece 30.

Details of a conventional fluid supply device 50 can be inferred from FIGS. 2A and 2B. Such a fluid supply device 50 comprises at least one fluid tank (not shown), a pump (not shown), and at least one line, to take fluid from the tank and pump it into an outlet nozzle 51. From there, the fluid sprays in the region of the machining zone BZ, for example, onto the region in which at the moment chips are removed at the workpiece 30 by the tool 20 (for example, during the gear tooth milling) or into the region in which at the moment chips are ground off on the workpiece 30 by the tool 20 (for example, during the gear tooth grinding).

The fluid supply device 50 or 250, respectively, is typically seated on the tool carrier 101 and moves in solidarity with it. I.e., the fluid supply device 50 or 250, respectively, follows the movements in the 3-dimensional space which the tool 20 executes, wherein the fluid supply device 50 or 250, respectively, does not rotate with the tool spindle 21 and the tool 20. It can be seen in FIG. 2A and FIG. 2B that the tool spindle 21 including tool 20 can have a rotationally-symmetrical envelope curve. This envelope curve describes the 3-dimensional space, in the rotation center of which the tool axis R1 is seated and which is either completely filled up by the tool spindle 21 including tool 20 (this is the case, for example, with a cup wheel 20 according to FIG. 2A or FIG. 2B), or which is covered during the rotation of a solid tool with blades, or a cutterhead, which is equipped with (bar) cutters. If one is located outside this envelope curve and moves in solidarity with the tool carrier 101, a collision does not result with the tool 20 while it rotates about the tool axis R1.

It can accordingly be seen in FIG. 2A that the fluid supply device 50 can be arranged, for example, in a ring shape around the spindle 21, and the outlet nozzle(s) 51 can be seated directly adjacent to the envelope curve or below an end face of the envelope curve, without colliding with the rotating tool 20.

The term “outlet nozzle 251” is used as follows here. It can be a complete nozzle, which can be coupled to a (ring) line 53 or another line (for example, a hose or pipe), or it can be the end section of a complete nozzle. In the latter case, the end section (also called the nozzle head here) is preferably designed for coupling to a nozzle base in all embodiments. Such a nozzle base can be able to be coupled in all embodiments to a (ring) line 53 or to another line (for example, a hose or pipe).

The outlet nozzles 251 of the invention are preferably high-pressure nozzles which are especially designed for discharging coolant liquid and/or lubricant liquid. This liquid/these liquids is/are generally referred to as fluid here.

In all embodiments (for example, as a nozzle base), the outlet nozzles 251 can have a tapering, self-sealing screw-in thread on the entry side (called docking point 252). In all embodiments, a standardized screw-in thread, press-in socket, or plug or screw coupling 259 is preferably used, so that the same interface can always be used for coupling on the outlet nozzles 251.

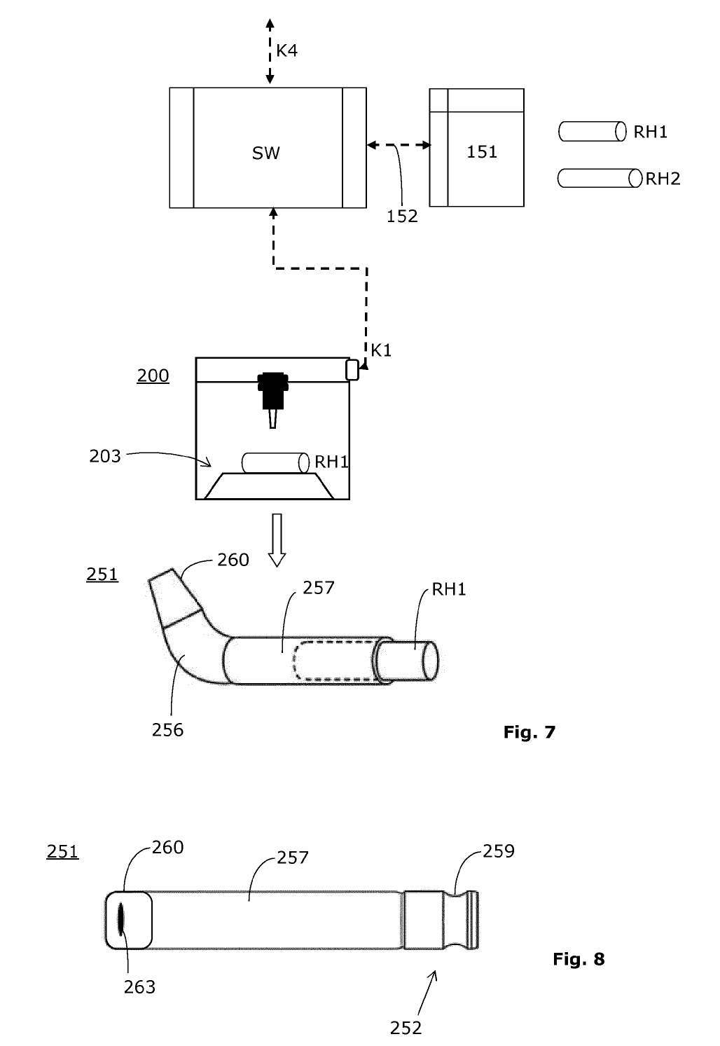

The end section (nozzle head 260) can preferably be designed in all embodiments such that it discharges a fixed fluid jet, or it atomizes or fans out the fluid during the exit from the outlet nozzle 251. Software SW (see also FIG. 7), which is used for the computer-assisted definition of the 3-dimensional shape and the position of a specifically adapted outlet nozzle 251, can optionally enable the definition of the exit behavior of the fluid in all embodiments.

The method of the invention can be decomposed into multiple partial steps, which are identified hereafter with the letters a., b., c. etc., wherein this designation does not necessarily also correspond to the chronological sequence of the individual steps, as they are finally executed.

More precise statements on the individual steps are made hereafter, wherein the corresponding letters are also used here, without interpreting this as restrictive.

Step a.: In this step, with the assistance of a computer (for example, using the computer 150 and/or a CPU of the machine tool 100), the 3-dimensional configuration of the machining zone BZ is defined in consideration of the workpiece 30 and the tool 20. The mentioned machining zone BZ is the space of the machine tool 100 which is to be used for machining the workpiece. The machining zone BZ is identified with an arrow in FIG. 4.

In the scope of step a., the definition of the machining zone BZ can be loaded from a memory in all embodiments. In this case, all important specifications were already ascertained beforehand and saved in the memory, to be able to retrieve them later.

In the scope of step a., however, the definition of the machining zone BZ can also take place computer-controlled step-by-step in all embodiments. This can be performed, for example, such that the user of the software SW has selection options offered on a display screen and/or by the user having to perform inputs on a display screen. In this manner, for example, the tool 20 can be defined, which is to be used, the workpiece 30 can be defined, and the machine type of the machine tool 100 can be established. The software SW can then ascertain the required information for the definition of the machining zone BZ from these specifications.

The machining zone BZ can be defined in all embodiments, for example, in a coordinate reference system or it can be defined, for example, as a point cloud.

During the definition of the machining zone BZ, the relative movements of tool 20 and workpiece 30 can already also be taken into consideration (for this purpose, for example, a collision observation can be carried out in a partial step). In this case, the definition of the machining zone BZ describes the available region of the 3-dimensional space which is available for the arrangement of the elements of the fluid supply device 250.

Step b.: This step relates to the computer-assisted definition of the 3-dimensional shape and the position of at least one specifically adapted outlet nozzle 251 of the fluid supply device 250. In this step b., information is used which was previously defined in step a. I.e., the 3-dimensional shape and the position of the outlet nozzle 251 to be manufactured is fitted by computer (virtually) into the available region of the 3-dimensional space of the machining zone BZ.

The concept of “computer-assisted definition” is also referred to as modeling. The computer-assisted definition can take place, for example, by means of the software SW, which is executed on the computer 150 (see FIG. 4) or in the machine tool 100. FIG. 4 shows an exemplary embodiment in which a computer 150 is connected via a communication connection K2 to the machine tool 100. The mentioned software SW is installed in this exemplary embodiment on the computer 150 and is executed in this computer 150, as schematically indicated in FIG. 4.

Preferably, in all embodiments, the shape of an outlet nozzle 251 is established by a sufficiently fine grid and provided as a dataset [DS] during the computer-assisted definition. The brackets are to express that the data of the dataset [DS] can be coded in a suitable form (for example, according to a communication or printing protocol).

The more finely the grid is defined, the finer the surface of the outlet nozzle 251 to be manufactured will finally be.

Step b. preferably supplies a dataset [DS] in all embodiments, which is compatible with commercially available machines and CAD programs. The (re-)usability of the dataset [DS] even in other machines and programs is thus ensured. Thus, for example, a representation of the just-modeled outlet nozzle 251 can be displayed on a display screen, to enable the user to perform a visual plausibility check. The display screen can be connected, for example, to the computer 150 and/or the machine tool 100.

The term “dataset” is used here as follows. The dataset [DS] contains the corresponding specifications which are necessary to machine a desired outlet nozzle 251 in a numerically-controlled manufacturing machine 200 (for example, proceeding from a blank RH1, RH2) or to completely manufacture it. I.e., the dataset [DS] is used more or less as a medium for the geometry transfer from a computer 150 or a machine tool 100, in which step b. is carried out, to a machine 200, in which step d. is carried out.

In all embodiments, the dataset [DS] comprises at least the geometry information of the modeled outlet nozzle 251 and in all embodiments it can comprise additional items of material information and/or color information.

In all embodiments, the dataset [DS] preferably defines the outlet nozzle 251 as a closed body, which can be manufactured layer by layer in an error-free manner in a material-constructing method (also called an additive manufacturing process).

In all embodiments, the dataset [DS] preferably defines the outlet nozzle 251 as a 3-dimensional object which is described by a closed envelope, which can consist, for example, of oriented (triangular) facets. Thus, for example, curved surfaces are approximated by polyhedrons. All surfaces from which the body of the outlet nozzle 251 is constructed are to fit together without gaps and overlaps. All details have to be completely modeled as the body and fused with the adjacent surfaces.

Step c.: This step relates to the provision of the dataset [DS], which describes the 3-dimensional shape of an outlet nozzle 251 to be manufactured. The provision can take place, for example, in all embodiments by saving the dataset [DS] at the end of step b. in a (buffer) memory, to then be retrieved therefrom (later) by a machine 200.

The provision can take place, for example, in all embodiments by transforming the raw data DS of the dataset into a suitable data format [DS].

The provision can take place, for example, in all embodiments by transferring the raw data DS and/or the dataset [DS] to a further process or further software.

FIG. 4 schematically shows that the dataset [DS] is provided via a communication connection K1 by the computer 150 for use by a material-depositing machine 200.

Step d.: This step relates to the use of the dataset [DS] in order to produce an outlet nozzle 251 by means of a numerically controlled manufacturing method.

In all embodiments, a material-depositing method is preferably used as the numerically-controlled manufacturing method. 3D printing methods are particularly preferred. In FIG. 3, the symbol of a material-depositing machine 200 is shown. Such a machine 200 can comprise, for example, at least one (print) head 201, means 202 for moving the (print) head 201, and a region 203 for manufacturing a component. Furthermore, an interface 204 can be provided, in order to receive the dataset [DS] (for example, via a communication connection K1).

The use of a 3D printer as the material-depositing machine 200 has the advantage that it can manufacture multiple individual objects simultaneously, even if these objects are interlocked. Moreover, 3D printing has the advantage that the complex production of molds and the changing of molds is dispensed with. A 3D printing method can therefore (in most cases) be operated automatically and without manual intervention. Present 3D printers furthermore have the advantage that they can manufacture complex 3-dimensional molds, which are not producible, for example, using existing milling centers.

3D printers are becoming more and more precise and can even print using multiple colors or materials. The typical datasets (for example, the Stereolithography Format; STL), cannot depict different materials and colors. If a machine 200 is thus to be used for manufacturing, which can process different materials and colors, in all embodiments, a dataset [DS] should thus be used, which also includes items of color and material information. For this purpose, in all embodiments, for example, the additive manufacturing file format (AMF) or the 3MF format can be used.

Materials which can be used in the scope of the invention in all embodiments are plastics, artificial resins, ceramics, and metals, and also combinations of two or more of these materials.

In order to withstand the printing procedure, the removal from the powder bath, the dusting, and the infiltration, a model has to be designed as correspondingly robust. For objects which are to be produced using a 3D printer, the minimum thickness for nonbearing elements is preferably 1 mm in all embodiments. Elements having light load should be approximately twice as thick. The minimum thickness of the main structures of the body of the outlet nozzle 251 should be thicker, since the outlet nozzle 251 is under fluid pressure and has fluid flow through it.

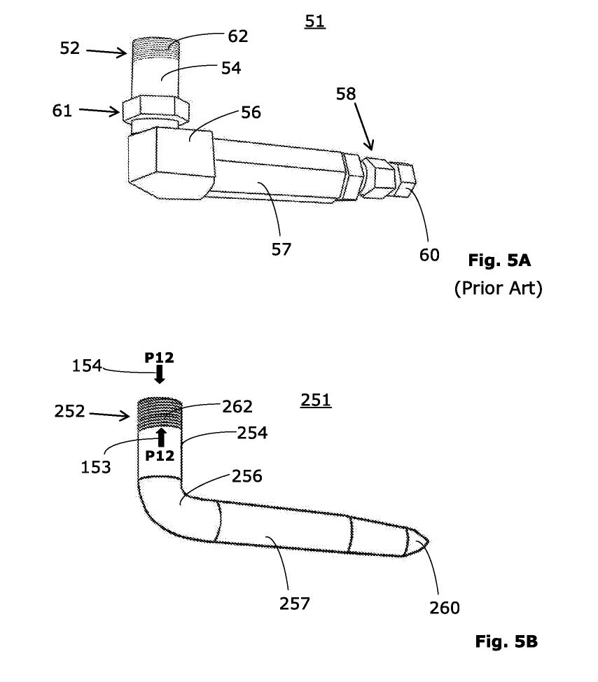

In FIGS. 5A and 5B, a conventional outlet nozzle 50 (FIG. 5A) is compared to an outlet nozzle 250 of the invention. Both nozzles 50, 250 were assembled or individually manufactured, respectively, for the same intended use.

Reference is made hereafter to FIG. 5A. Proceeding from the docking point 52 (which is designed, for example, for coupling to a ring line 53), a conventional outlet nozzle 50 can comprise, for example, the following elements: a line piece 54 having external thread 62; a knee element 56, which is fastened by means of a union nut 61 on the line piece 54; a further line piece 57, which is connected to the knee element 56; a nozzle head 60, which is screwed together with the line piece 57 by means of a screw connection 58.

Reference is made hereafter to FIG. 5B. Proceeding from the docking point 252 (which is designed, for example, for coupling to a ring line 253), an outlet nozzle 250 of the invention can comprise, for example, the following elements: a line section 254 having external thread 262; a knee section 256, which merges into the line section 254; a further line section 257, which merges into the knee element 56; a nozzle head 260, which is formed at the end of the line section 257.

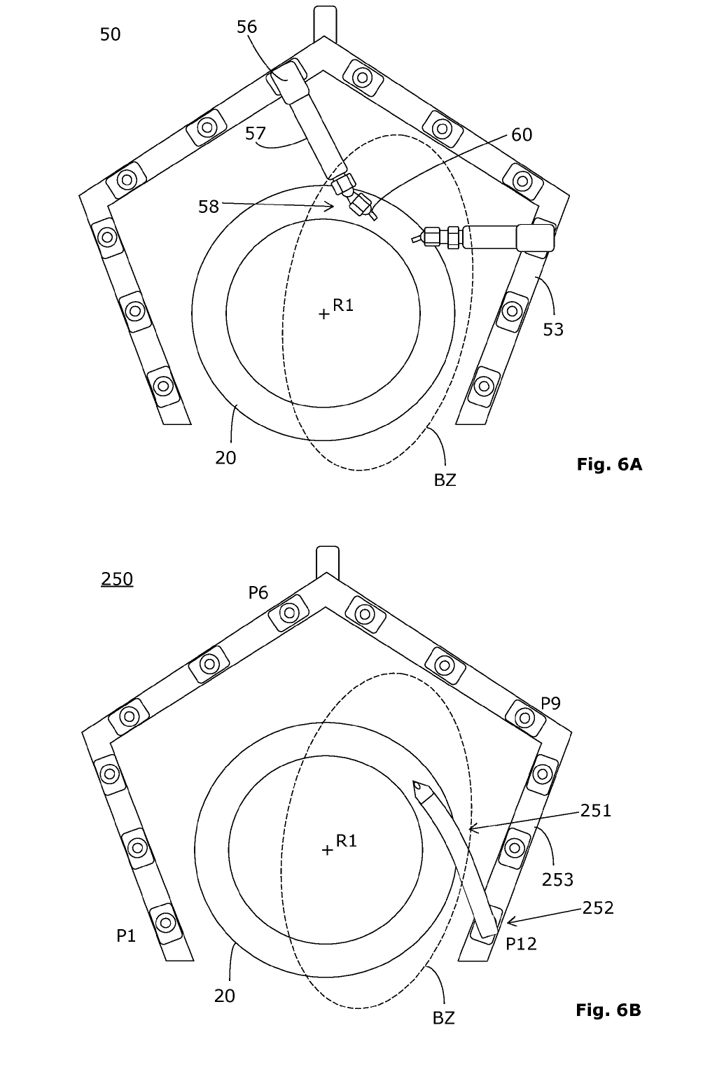

In FIGS. 6A and 6B, a conventional fluid supply device 50 having two outlet nozzles 51 of the prior art (FIG. 6A) is compared to a fluid supply device 250 having a specially manufactured outlet nozzle 251 of the invention. The outlet nozzle 251 was individually manufactured for the desired intended purpose according to the steps of the invention. The two ring lines 53 and 253, respectively, of FIGS. 6A and 6B are identical.

The individually manufactured outlet nozzles 251 of the invention are preferably distinguished in that they are integral. I.e., the outlet nozzles 251 of the invention preferably consist in all embodiments of only one part, which can have been manufactured from different materials, however (depending on the method).

The outlet nozzles 251 of the invention can also comprise a blank (for example, RH1 or RH2) in all embodiments, which was selected, for example, in a partial step of step b. (see also FIG. 7).

The blank (for example, RH1 or RH2) can comprise, in all embodiments, for example, the (standardized) elements (for example, an internal or external thread, or a plug or screw coupling 259), which are designed for connecting (coupling) the outlet nozzle 251 to a ring line 253 or to another line. In this case, the blank (for example, RH1 or RH2) is modified by the numerically controlled manufacturing method in step d. (for example, by CNC-controlled milling) or the blank (for example, RH1 or RH2) is introduced into a material-depositing machine 200 and provided with additional material (see also FIG. 7).

Further details of the invention will be explained on the basis of FIG. 7. This is an illustration of a preferred embodiment in the manner of a flow chart. The software SW can receive information from step a. via a communication connection K4 (for example, via a computer-internal connection in the computer 150 or in the machine tool 100). Blanks RH1 and RH2 can be offered for selection from a memory 151. The software SW can perform a selection automatically (in consideration of the information of step a.), or the user can make a suitable selection (for example, in consideration of the stock of various blanks RH1, RH2).

In the embodiment shown in FIG. 7, two blanks RH1 and RH2 are offered for selection, which only differ in the length. For short outlet nozzles 251, the blank RH1 would therefore be selected and for longer outlet nozzles 251, the blank RH2 would be selected.

The 3-dimensional shape and position of a specifically adapted outlet nozzle 251 is now defined in step b. with computer assistance. This can be carried out by the software SW, as shown in FIG. 7. The software SW can then provide a suitable dataset [DS] via a communication connection K1 for use by a material-depositing machine 200.

It is furthermore schematically indicated in FIG. 7 that the blank (the blank RH1 was selected here) is located in the machine 200 in the region 203, where it is subjected to material-depositing machining. An outlet nozzle 251 is shown in solely schematic form as an example in FIG. 7 below the machine 200. It can be seen that the blank RH1 extends somewhat into the interior of a line section 257. The line section 257 merges here into a knee section 256, which opens into a nozzle head 260.

A further embodiment of an outlet nozzle 251 is schematically indicated in FIG. 8. The outlet nozzle 251 is shown from below (i.e., with view of the nozzle slot 263) in FIG. 8. In the region of the docking point 252, this outlet nozzle 251 comprises a plug coupling 259. The nozzle head 260 comprises an oblong nozzle slot 263, which is designed to spread out the exiting fluid jet.

The method for providing a fluid supply device 250, which is especially designed for use in a machining zone BZ of a machine tool 100, preferably comprises the following steps:

a. computer-assisted definition of the 3-dimensional configuration of the machining zone BZ in consideration of the workpiece 30 and the tool 20, which is to be used for machining the workpiece 30 in the machining zone BZ of the machine tool 100,

b. computer-assisted definition of the 3-dimensional shape in the position of at least one specifically adapted outlet nozzle 251 of the fluid supply device 250 with incorporation of information which was defined in step a.,

c. providing a dataset (DS; [DS]), which describes the 3-dimensional shape of this outlet nozzle 251,

d. using the dataset (DS; [DS]), in order to produce this outlet nozzle 251 by means of a numerically controlled manufacturing method (for example, in a material-depositing machine 200 and/or in a material-removing machine 300).

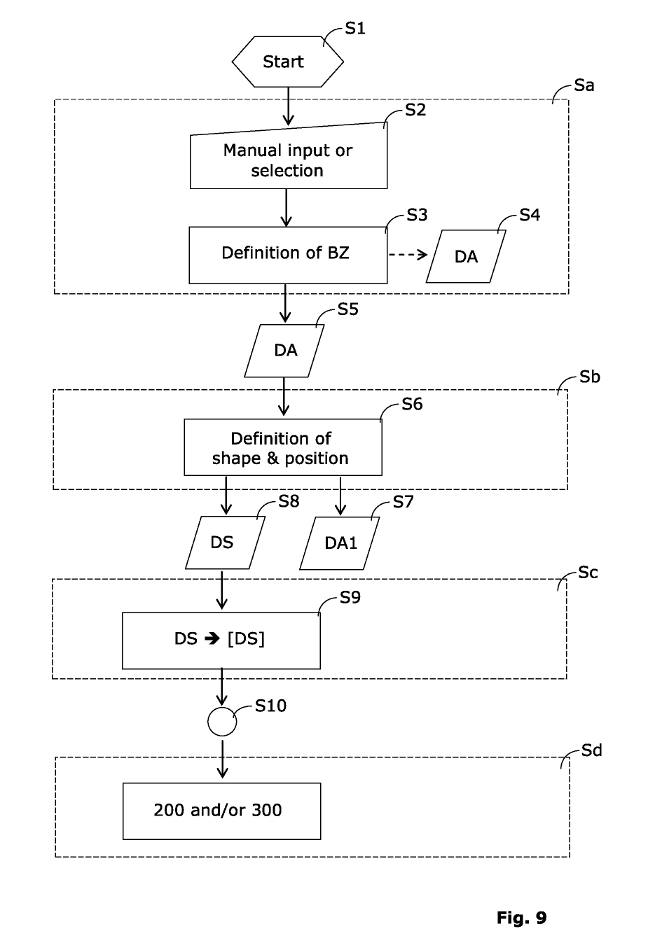

Specifically, the method can comprise the following partial steps/processes in all embodiments, as shown in FIG. 9.

After the start of a corresponding (software) application (step S1) on a computer 150 or in the machine 100, the user, for example, can be requested to input information or to select information (step S2). Instead, this step S2 can also take place automatically (for example, in that the corresponding information is available to the machine 100 in other ways).

The actual definition of the machining zone BZ then follows (step S3). Step S3 is preferably carried out automatically, wherein (depending on the embodiment) static and/or dynamic collision information can be taken into consideration.

The data DA thus obtained can optionally be (temporarily) stored in step S4. The data DA thus obtained are provided for the sixth step (step S5).

In the scope of the sixth step, both the shape and also the position of the outlet nozzle 251 to be manufactured are defined (ascertained by computer). In the scope of the sixth step, inter alia, the information is taken into consideration which was provided in step S5. If the outlet nozzle 251 is to be fastened on a ring line 253, the position can thus comprise, for example, a port number (for example, P1 to P12) and an angle specification. In the example in FIG. 6B, the position could be defined, for example, as follows: P12:355. P12 designates the twelfth port of the ring line 253 and the number 355 stands for 355° (measured clockwise, wherein 0° corresponds to the 12 o'clock position, 180° to the 6 o'clock position, and 360° again to the 12 o'clock position). The position can be provided in all embodiments, for example, as a dataset DA1 (step S7).

As already mentioned, the 3-dimensional shape of the outlet nozzle 251 can be defined, for example, by a closed-surface body, which is composed of a large number of small facets. Finally, the definition of the 3-dimensional shape can supply, for example, a dataset DS (step S8).

The 3-dimensional shape which was ascertained is codified in the dataset DS or it is defined by the dataset DS. Step S8 corresponds to the step of providing the dataset DS. This dataset DS can be provided in the present form for further use or it can be converted, for example, into another format [DS] (step S9). Step S9 is optional.

Step S10 represents the provision of the dataset DS or [DS]. The numerically controlled manufacturing method 200 and/or 300 begins at the corresponding point in the flow chart of FIG. 9.

Preferably, in all embodiments, the position (for example, in the form of the dataset DA1) is also used in the ninth step, specifically to provide the outlet nozzle 251 with corresponding information. In FIG. 5B, this is illustrated by way of example as follows. An arrow 153 having the inscription P12 can be applied to the body of the outlet nozzle 251, for example, (which can also take place, for example, in the scope of the 3D printing or by milling). A port number of 1 to 12 and a further arrow 154 can be provided at each port on the ring line 253, as indicated in FIG. 5B. The user of the invention can now recognize by checking the specially manufactured outlet nozzle 251 that this outlet nozzle 251 is to be coupled on the port P12 of the ring line 253, and during the alignment of the outlet nozzle 251 in relation to the ring line 253, the two arrows 153 and 154 have to be aligned with one another. The outlet nozzle 251 can thus be fastened without problems and reliably at the correct position and in the correct orientation.

In this example, the dataset DS or [DS] thus does not only comprise the data on the shape of the outlet nozzle 251, but rather also specifications on the inscription or identification of the outlet nozzle 251.

List of reference signs

| | |
|---|---|
| tool | 20 |
| tool spindle | 21 |
| workpiece/component to be machined | 30 |
| fluid supply device | 50 |
| outlet nozzle | 51 |
| docking point | 52 |
| ring line | 53 |
| line piece | 54 |
| screw connection | 55 |
| knee element | 56 |
| line piece | 57 |
| screw connection | 58 |
| plug or screw coupling | 59 |
| nozzle head | 60 |
| union nut | 61 |
| external thread | 62 |
| machine tool | 100 |
| tool carrier | 101 |
| machine bed | 102 |
| workpiece spindle | 103 |
| computer | 150 |
| memory | 151 |
| memory access/bus | 152 |
| arrow | 153 |
| material-depositing machine | 200 |
| (print) head | 201 |
| means for moving the (print) head | 202 |
| region | 203 |
| interface | 204 |
| outlet nozzle | 251 |
| docking point | 252 |
| line section | 254 |
| knee section | 256 |
| line section | 257 |
| plug or screw coupling | 259 |
| nozzle head | 260 |
| external thread | 262 |
| nozzle slot | 263 |
| machining zone | BZ |
| pivot axis | C |
| computerized numerical control | CNC |
| data | DA, DA1 |
| raw data | DS |
| data set | [DS] |
| communication connections | K1, K2, K3, K4 |
| port number | P1-P12 |
| tool axis | R1 |
| workpiece axis | R2 |
| horizontal axis | R3 |
| blanks | RH1, RH2 |
| method steps | S1, S2, S3, etc. |
| step a. | Sa |
| step b. | Sb |
| step c. | Sc |
| step d. | Sd |
| software (module) | SW |
| linear axis | X |
| linear axis | Y |
| linear axis | Z |
| rotational movement of the tool | ω1 |
| rotational movement of the workpiece | ω2 |

1. A method of making a fluid supply device, for use in a machining zone of a machine tool to discharge a fluid in a direction of an interaction region between a tool and a workpiece, comprising the following steps:
a. generating a computer-assisted definition of a 3-dimensional configuration of the machining zone based on the workpiece and the tool for machining the workpiece in the machining zone of the machine tool,
b. generating a computer-assisted definition of a 3-dimensional shape and a position of at least one outlet nozzle of the fluid supply device using information defined in step a.,
c. generating a dataset defining the 3-dimensional shape of the at least one outlet nozzle,
d. manufacturing the at least one outlet nozzle using the dataset and using a numerically controlled manufacturing method.

2. The method according to claim 1, wherein the numerically controlled manufacturing method comprises a material-depositing method.

3. The method according to claim 1, wherein step b. further includes using a static and a dynamic relative position of the workpiece and the tool.

4. The method according to claim 3, wherein step b. further includes performing a collision ascertainment to define the 3-dimensional shape of the outlet nozzle such that a collision does not occur in the machining zone during a use of the outlet nozzle.

5. The method according to claim 3, wherein step b. further includes performing a flow observation to define the 3-dimensional shape of the outlet nozzle such that the fluid can be discharged as a direct fluid jet in the direction of the interaction region between the tool and the workpiece.

6. The method according to claim 1, further including selecting at least one blank of an outlet nozzle from one or more of a storage medium or via a communication connection, and wherein, in step d., the at least one blank is introduced into a manufacturing machine and adapted or supplemented by the numerically controlled manufacturing method.

7. The method according to claim 1, wherein steps a. to c. are performed by a computer or the machine tool, and further including transferring the dataset to a manufacturing machine located remotely from the computer or the machine tool.

8. The method according to claim 1, further including providing the outlet nozzle with an identifier adapted for use in installing the outlet nozzle.

9. (canceled)

10. A method according to claim 2, wherein the material-deposting method comprises a 3D printing method.

11. A fluid supply device comprising:
at least one outlet nozzle configured for use in a machining zone of a machine tool and to discharge fluid in a direction of an interaction region between a tool and a workpiece, and made by a process comprising the steps of:
a. generating a computer-assisted definition of a 3-dimensional configuration of the machining zone based on the workpiece and the tool for machining the workpiece in the machining zone of the machine tool,
b. generating a computer-assisted definition of the 3-dimensional shape and a position of at least one outlet nozzle of the fluid supply device using information defined in step a.,
c. generating a dataset defining the 3-dimensional shape of the at least one outlet nozzle,
d. manufacturing the at least one outlet nozzle using the dataset and using a numerically controlled manufacturing method.
